(19) United States
(12) Patent Application Publication
(10) Pub. No.: US 2005/0173560 A1
(43) Pub. Date: Aug. 11, 2005

(54) Trigger sprayer with ergonomic trigger

(76) Inventors: Bruce K. Bitowft, Oakland, CA (US); Humberto F. Rodriguez, Oakland, CA (US)

Correspondence Address: THE CLOROX COMPANY, 1221 BROADWAY PO BOX 2351, OAKLAND, CA, 94623, US

(21) Appl. No.: 10/776,543

(22) Filed: Feb. 10, 2004

(51) Int. Cl. B05B 9/03

(52) U.S. Cl. 239/302

(57) ABSTRACT

An improved manually operated trigger sprayer includes an ergonomic trigger having an hourglass exterior finger gripping surface that can significantly reduce or eliminate the fatigue associate with prolonged use of trigger sprayers. The trigger can include gripping elements made of elastomeric material for improved security. The dimensions are such that the consumer can use two or three fingers to operate the trigger.

### FIELD OF THE INVENTION

This invention relates to the field of manually operated trigger sprayers for dispensing liquids from bottles and similar containers, and more particularly to a trigger actuated pump sprayer with an ergonomic trigger which enables consumers to operate the sprayer for extended periods of time with ease.

### BACKGROUND OF THE INVENTION

Manually operated trigger sprayers for dispensing liquids from a bottle or a similar container are well known and are in wide use in connection with the application of home cleaning products. Such dispensers-provide a convenient means of dispensing, applying and using such home cleaning products. A variety of such trigger sprayers is known in the prior art.

Trigger actuated pump sprayers are typically mounted on the neck of a container of a liquid product to be dispensed. In use, the consumer grasps the container neck and the closure cap provided for mounting the trigger sprayer to the container. The consumer dispenses the product by engaging the trigger lever for stroking the pump for dispensing. Depending on the product being dispensed and/or the task at hand, sprayers can be used to dispense small quantities of product on an occasional basis or can be used to dispense larger amounts of product over an extended period of time. In the latter case, the consumer often experiences fatigue especially if the container is large and heavy.

The art is in search of improved trigger sprayers that allow consumers to operate the sprayers more conveniently for prolonged periods of time without incurring the discomforts associated with using prior art devices.

### SUMMARY OF THE INVENTION

The invention is based, in part, on the demonstration that incorporating an improved ergonomic trigger to manually operated pump sprayers can significantly reduce or eliminate the fatigue associate with prolonged use of trigger sprayers.

In one aspect, the invention is directed to a trigger for a sprayer that includes a housing with a pump therein wherein the sprayer is manually actuated by the reciprocating action of a pump, the trigger including: a lever, which is pivotally mounted on the housing for engaging the pump, and that comprises an elongated lever having a finger engaging surface that includes an upper section, a middle section, and a lower section, wherein the middle section has a width that is shorter than the widths of the upper section and of the lower section.

In another aspect, the invention is directed to a trigger sprayer for manually dispensing fluid from a container that includes:
a housing that defines a pump therein wherein the pump is actuated by a reciprocating mechanism;
an inlet passageway for connecting fluid from a container to the pump;
an outlet passage for allowing exit of fluid from the pump; and
a trigger operatively connected with the pump, wherein the trigger comprises an elongated lever, which is attached to the actuator, the lever defining a finger engaging surface that includes an upper section, a middle section, and a lower section, wherein the middle section has a width that is shorter than the widths of the upper section and of the lower section.

In yet another embodiment, the invention is directed to a trigger sprayer for manually dispensing fluid from a container that includes:
a housing defined by at least two side walls, a top wall, and a bottom wall which is adapted for supporting the sprayer on a user's hand;
a pump situated within the housing;
an inlet passageway for connecting fluid from a container to the pump;
an outlet passage for allowing exit of fluid from the pump; and
a trigger operatively connected with the pump, wherein the trigger comprises an elongated lever defines a finger engaging surface that includes an upper section, a middle section, and a lower section, wherein the middle section has a width that is shorter than the widths of the upper section and of the lower section, characterized in that the elongated lever has dimensions that permit the user to pull the trigger repeatedly with at least two fingers while grasping the handle of the sprayer.

### BRIEF DESCRIPTION OF THE DRAWINGS

FIG. 1 is a side perspective view of a pump dispenser of the present invention;

FIG. 2 is the front elevation view of the pump body;

FIGS. 3 and 4 are perspective views of the pump body;

FIG. 5 is a sectional view of the pump body;

FIG. 6 is a perspective view of the trigger;

FIG. 7 is a front elevation view of the trigger;

FIG. 8 is a rear elevation view of the trigger;

FIGS. 9 and 10 are the right and left side elevation views of the trigger, respectively;

FIG. 11 is a top plan view of the trigger; and

FIG. 12 is a bottom plan view of the trigger.

### DESCRIPTION OF THE PREFERRED EMBODIMENTS

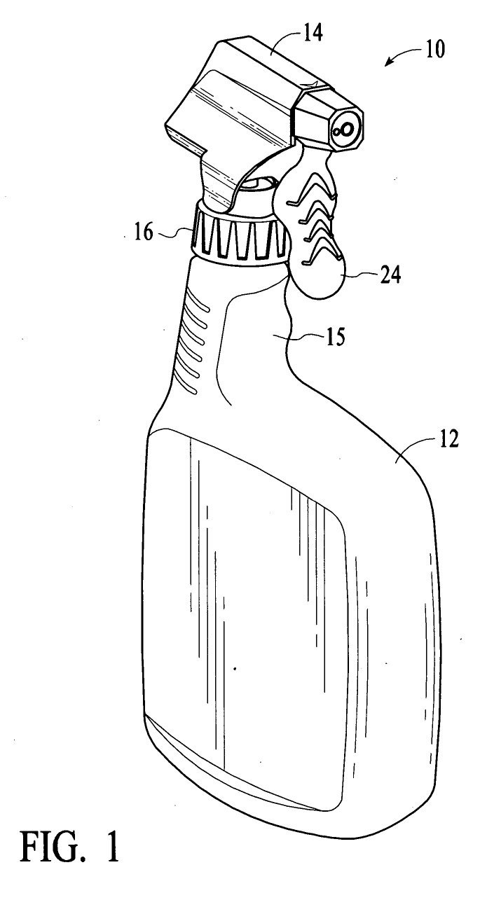

Referring to FIG. 1, a pump dispenser 10, which embodies the invention, generally comprises a liquid-filled container 12 and a pump body 14 that is releasably connected to the neck 15 of the container 12 with a collar or closure cap 16. The pump dispenser 10 is manually actuated with trigger 24 and is particularly suited for spraying a liquid cleaning agent such as a conventional all purpose cleaner. As will be further described, the ergonomically designed hourglass-shaped trigger 24 enables an individual to operate the pump dispenser 10 for longer periods of time without experiencing hand and/or finger fatigue vis-à-vis dispensers with conventional triggers.

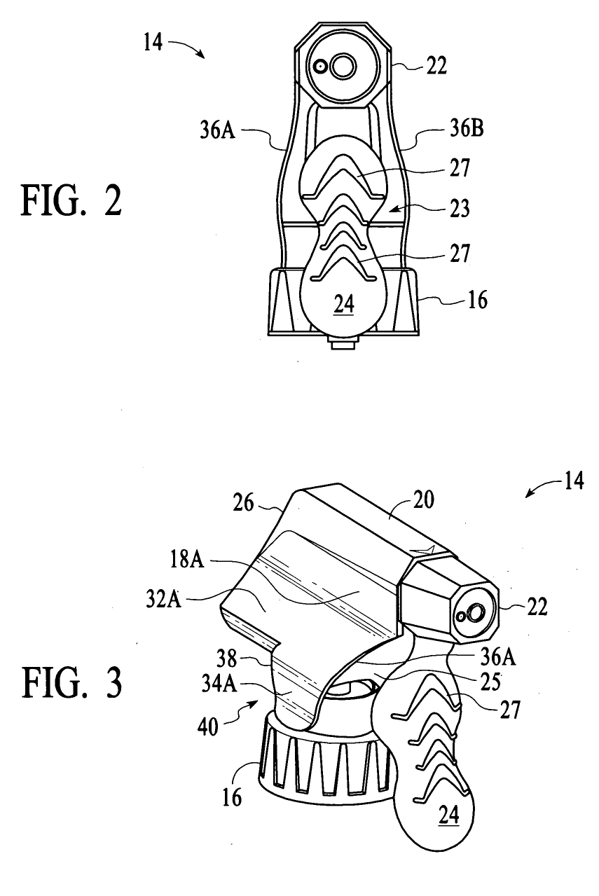

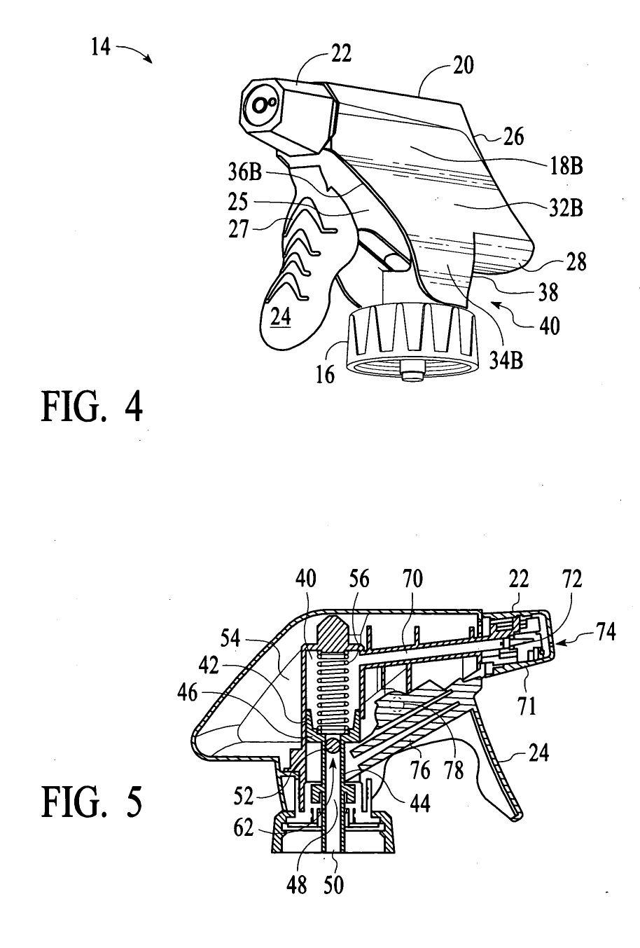

As illustrated in FIGS. 2-4, the exterior features of the pump body 14 include: (1) parallel upper sidewalls 18A, 18B, (2) parallel middle sidewalls 32A, 32B, (3) parallel lower sidewalls 34A, 34B, (4) a top wall 20 that blends into (5) an inclined upper rear wall 26, and (6) a bottom facing support surface 28. (The exterior covering of the pump body is often referred to the shroud.) A nozzle cap 22 and a pivoted trigger 24 are disposed on the front end of the pump body 14. The front edges of the middle sidewalls 32A, 32B and lower sidewalls and 34A, 32B, collectively define the forward perimeters 36A, 36B of the pump body 14 which form the perimeter of aperture 23. The pivoted trigger 24 is operatively connected by the arm 25 to a piston (not shown); the arm 25 is positioned within the aperture 23 being bordered by forward perimeters 36A and 36B.

The upper and middle sidewalls 18A, 18B and 32A, 32B, respectively extend longitudinally and continuously between their edges to the rear wall 26. The lower sidewalls 34A, 34B extend between their front edges to the lower rear wall 38. The lower sidewalls 34A, 34B and lower rear wall 38 define a constricted throat portion 40 situated immediately above the collar 16.

The support surface 28 is dimensioned to fit on the web of a person's hand when the sprayer is being operated. In addition, the size and configuration of the exterior contour of the throat 40 are selected to enable a person to readily grasp the sprayer with the palm of his hand essentially surrounding the collar 16 and bottle neck 15 such that the web of the hand between the thumb and forefinger underlie the support surface 28. The thumb, forefinger and hand web likewise grip about the constricted throat portion 40. The user can manipulate the trigger lever 24 by the forefinger and/or middle finger by pulling the trigger to actuate the pump. As will be further described, for maximum comfort the ergonomic trigger of the present invention is configured to be pulled using two or three fingers.

The front surface of the trigger 24 preferably includes a plurality of gripping elements 27 that are formed on the recesses in the trigger body. As illustrated in FIGS. 2-4, in one embodiment, four gripping elements that form a chevron pattern are provided. The gripping elements can be formed from an elastomeric material, such as rubber or a synthetic rubber-compound such as polyurethane, silicone-rubber and the like. In addition, the grips can be textured so as to present a rough surface for added security so that the person's fingers do not inadvertently slip off even when the grip surface is wet.

The front surface of the trigger 24 has an hourglass-shaped perimeter and, in one embodiment, a generally continuous, slightly concave contour extending along its length from the proximal (or upper) to distal end of the trigger. Alternatively, the front surface can exhibit a center bulge that protrudes outward to create a slight protrusion along a center of the front surface that traverses longitudinally along the middle of the gripping elements 27.

FIG. 5 illustrates the internal mechanism of the pump body 14 which when activated delivers a liquid product from the container (not shown) through the aperture in the nozzle 22. A pump chamber 40 is disposed within the housing 54 of the pump body. A fluid supply and discharge assistant 44 includes a piston 46 and a piston conduit 48 that provides fluid to the pump chamber 40 from the container. The piston conduit 48 may be provided with an inlet conduit or dip tube 50 that is adapted to extend into the container to draw fluid into the pump chamber 40 via the piston conduit 48 and an inlet ball check valve 52. The slideable piston 46, which is reciprocally disposed inside the pump chamber 40, is actuated against the bias of a coil spring 56 by squeezing trigger 24 thereby reducing the enclosed volume within the pump chamber 40.

A flexible member 42 in contact with the piston 46 functions as the movable portion of the inlet ball valve and as a piston ring. The piston conduit orifice 62 may be blocked in response to pressure within the pump chamber 40 by the ball 52 of the inlet ball valve.

Fluid in the pump chamber 40 may be discharged from the dispenser through an outlet conduit 70 and a nozzle fitting 71. The nozzle fitting carries an operative discharge check valve 72. The fitting 71 and check valve 72 are enclosed in a nozzle cap 22 which, depending on its position, controls the form of discharge, e.g., stream or spray. The discharge path includes outlet orifice 74 which is shown in the “off” position in FIG. 5 as not being aligned with or in communication with the outlet conduit 70. The trigger sprayer of the present invention can employ a variety of nozzles with the choice depending on a number of considerations such as (1) the size and/or shape of the spray pattern and (2) level of foaming desired. For example, the nozzle may have outlet orifices of different sizes, i.e., diameters, or orifices with different configurations. Typically, the consumer can select the appropriate operating parameter(s), e.g., spray pattern, by rotating the nozzle cap 22. Suitable nozzles are well known in the art and are described, for example, in U.S. Pat. No. 4,313,568 to Shay and U.S. Pat. No. 6,446,882 to Dukes et al. which are incorporated herein by reference.

The trigger 24 is pivotally attached to the projections 78 located on opposite sides of the housing. The reciprocating arm 76 is attached the trigger 24 on one end and operatively connected to the piston 46 on the other end. The reciprocating action of the pump dispenser is initiated from the downward position of the piston 46. As the trigger 24 is pulled toward the collar 16 to raise the piston 46, forcing liquid in the pump chamber 40 out delivery tube 70 and through the discharge check valve 72 and the orifice 74. When the trigger 24 is released, the spring 56 pulls the piston 46 downward, creating a negative pressure in the pump chamber 40 and causing the ball 52 of the ball valve to raise off the valve seat drawing liquid from the piston conduit 48 upward into the chamber 40. In the event that the pump chamber 40 is empty, it is necessary to “prime” the pump by retracting the trigger 24 a few times before the pump chamber 40 is adequately filled with liquid.

The particular internal pump mechanism is not critical to the invention. The improved ergonomic trigger can be employed with conventional manually actuated piston or bellows-type pumps that are described, for example, in U.S. Pat. No. 4,227,650 to McKinney, U.S. Pat. No. 4,538,745 to Dunning et al., U.S. Pat. No. 6,213,236 to Bloom, U.S. Pat. No. 6,234,361 to Bloom, U.S. Pat. No. 6,332,562 to Sweeton, and U.S. Pat. No. 6,364,175 to Bloom Which are all incorporated herein by reference.

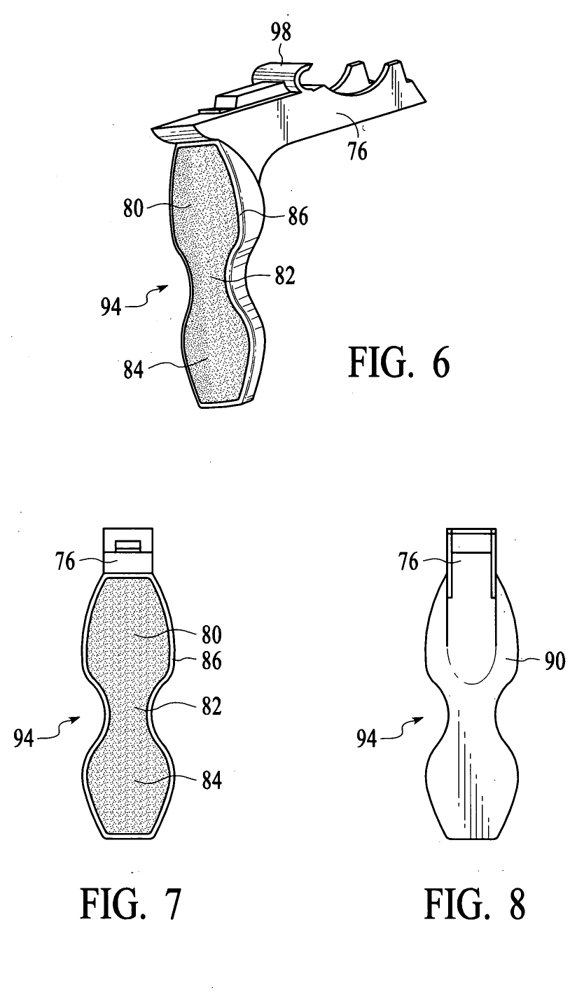

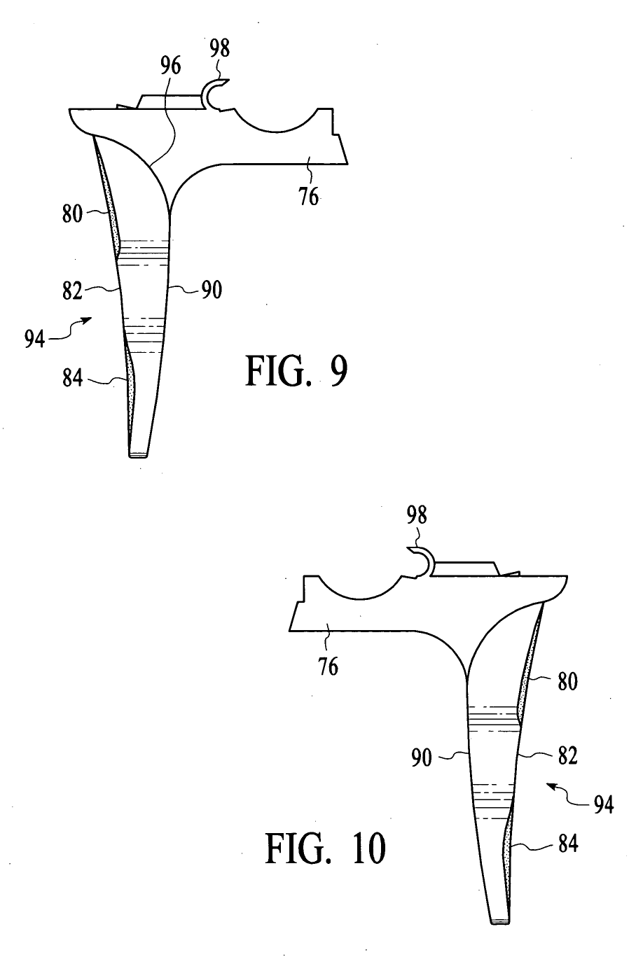

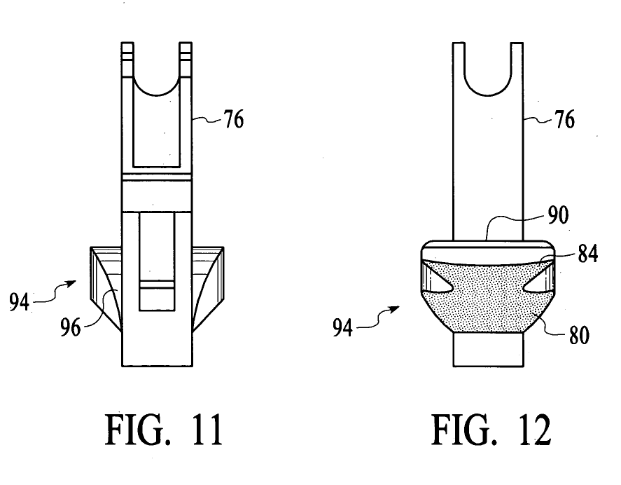

FIGS. 6 to 12 illustrate another embodiment of the ergonomic trigger 94 with its generally hourglass-shaped front exterior contour 80, 82, and 84. The exterior contour preferably defines a continuous, slightly concave smooth surface. In this embodiment, the gripping surface is textured and covers essentially the entire front surface of the trigger 94. The body of the trigger 94 is preferably made of a hard molded plastic and the gripping surface is embedded within a recess with the body surface. At least a portion of the edge 86 of the body of the trigger 94 where the fingers are in contact with the trigger 94 is rounded for ease of handling.

The front finger-grasping surface comprises three sections: (1) an upper section 80, (2) a middle section 82, and (3) a lower section 84. To permit a consumer to use 2 or 3 fingers to engage the trigger 94, the finger engaging surface preferably has an overall length of about 45 mm to 65 mm, as measured along its surface. In addition, the upper section 80 preferably has a width of about 17 mm to 27 mm, the middle section 82 preferably has a width of about 7 mm to 16 mm, and the lower section 84 preferably has a width of about 17 mm to 27 mm. Finally, the upper section 80 preferably has a length of about 17 mm to 25 mm, the middle section preferably has a length of about 11 mm to 15 mm, and the lower section preferably has a width of about 17 mm to 25 mm. As illustrated, in a preferred embodiment of the trigger, the hourglass front exterior configuration as an upper section 80 with dimensions that are substantially identical to those of the lower section 84.

The configuration of the back surface 96 of the trigger 94 as illustrated in FIGS. 6-12, generally has an aesthetically convex exterior surface. The trigger 94 at the upper portion of the back surface 96 is attached to an arm 76, which is adapted to mate with the piston 46. The arm 76 includes a spiral-shaped member 98 which pivots on an a projecting peg 78 located on opposite sides of the housing (FIG. 5).

In use, a consumer grasps the container neck and the and at least the collar such that the container is supported at the user's hand by the rearwardly extending support surface 28 (FIG. 2) which rests upon the top of the user's hand at the web of the hand between the thumb and the forefinger. The forefinger (or the forefinger and middle finger) engages the trigger lever for stroking the pump for dispensing the product. The size and shape of the ergonomic trigger intuitively positions the fingers over the exterior surface of the trigger.

While various advantageous embodiments have been chosen to illustrate the present invention, it will be understood by those skilled in the art that various changes and modifications can be made therein without departing from the scope of the invention as defined in the appended claims.

1. A trigger for a sprayer that includes a housing with a pump therein wherein the sprayer is manually actuated by the reciprocating action of a pump, the trigger comprising: a lever, which is pivotally mounted on the housing for engaging the pump, and that comprises an elongated lever having a finger engaging surface that includes an upper section, a middle section, and a lower section, wherein the middle section has a width that is shorter than the widths of the upper section and of the lower section.

2. The trigger of claim 1 wherein the finger engaging surface has a concave shaped contour.

3. The trigger of claim 1 wherein the finger engaging surface includes at least one gripping surface area.

4. The trigger of claim 3 wherein the at least one gripping surface area is made from an elastomeric material.

5. The trigger of claim 1 wherein the finger engaging surface has an hourglass configuration.

6. The trigger of claim 1 wherein the finger engaging surface is about 45 mm to 65 mm in length.

7. The trigger of claim 6 wherein the upper section has a width of about 17 mm to 27 mm, the middle section has a width of about 7 mm to 16 mm, and the lower section has a width of about 17 mm to 27 mm.

8. The trigger of claim 7 wherein the upper section has a length of about 17 mm to 25 mm, the middle section has a length of about 11 mm to 15 mm, and the lower section has a width of about 17 mm to 25 mm.

9. The trigger of claim 8 wherein the front finger engaging surface has an hourglass configuration such that upper section has dimensions that are substantially identical to those of the lower section.

10. The trigger of claim 1 wherein the pump includes a pump chamber and the upper section of the lever is operatively attached to a reciprocally slideable piston within the pump chamber.

11. The trigger of claim 1 wherein at least a portion of the perimeter edge of the finger engaging surface is rounded.

12. A trigger sprayer for manually dispensing fluid from a container comprising:
a housing that defines a pump therein wherein the pump is actuated by a reciprocating mechanism;
an inlet passageway for connecting fluid from a container to the pump;
an outlet passage for allowing exit of fluid from the pump; and
a trigger operatively connected with the pump, wherein the trigger comprises an elongated lever, which is attached to the actuator, the lever defining a finger engaging surface that includes an upper section, a middle section, and a lower section, wherein the middle section has a width that is shorter than the widths of the upper section and of the lower section.

13. The trigger sprayer of claim 12 wherein the finger engaging surface has a concave shaped contour.

14. The trigger sprayer of claim 12 wherein the finger engaging surface includes at least one gripping surface area.

15. The trigger sprayer of claim 14 wherein the at least one gripping surface area is made from an elastomeric material.

16. The trigger sprayer of claim 11 wherein the finger engaging surface has an hourglass configuration.

17. The trigger sprayer of claim 11 wherein the finger engaging surface is about 45 mm to 65 mm in length.

18. The trigger sprayer of claim 17 wherein the upper section has a width of about 17 mm to 27 mm, the middle section has a width of about 7 mm to 16 mm, and the lower section has a width of about 17 mm to 27 mm.

19. The trigger sprayer of claim 18 wherein the upper section has a length of about 17 mm to 25 mm, the middle section has a length of about 11 mm tol 5 mm, and the lower section has a width of about 17 mm to 25 mm.

20. The trigger sprayer of claim 19 wherein the front finger engaging surface has an hourglass configuration such that upper section has dimensions that are substantially identical to those of the lower section.

21. The trigger sprayer of claim 12 wherein the pump comprises a pump chamber with a piston reciprocally slideably positioned therein and the upper section of the lever is operatively attached to the piston.

22. The trigger sprayer of claim 12 wherein at least a portion of the perimeter edge of the finger engaging surface is rounded.

23. A trigger sprayer for manually dispensing fluid from a container comprising:
a housing defined by at least two side walls, a top wall, and a bottom wall which is adapted for supporting the sprayer on a user's hand;
a pump situated within the housing;
an inlet passageway for connecting fluid from a container to the pump;
an outlet passage for allowing exit of fluid from the pump; and
a trigger operatively connected with the pump, wherein the trigger comprises an elongated lever defines a finger engaging surface that includes an upper section, a middle section, and a lower section, wherein the middle section has a width that is shorter than the widths of the upper section and of the lower section, characterized in that the elongated lever has dimensions that permit the user to pull the trigger repeatedly with at least two fingers while grasping the handle of the sprayer.

24. The trigger sprayer of claim 23 wherein the finger engaging surface has a concave shaped contour.

25. The trigger sprayer of claim 23 wherein the finger engaging surface includes at least one gripping surface area.

26. The trigger sprayer of claim 25 wherein the at least one gripping surface area is made from an elastomeric material.

27. The trigger sprayer of claim 23 wherein the finger engaging surface has an hourglass configuration.

28. The trigger sprayer of claim 23 wherein the finger engaging surface is about 45 mm to 65 mm in length.

29. The trigger sprayer of claim 28 wherein the upper section has a width of about 17 mm to 27 mm, the middle section has a width of about 7 mm to 16 mm, and the lower section has a width of about 17 mm to 27 mm.

30. The trigger sprayer of claim 29 wherein the upper section has a length of about 17 mm to 25 mm, the middle section has a length of about 11 mm to 15 mm, and the lower section has a width of about 17 mm to 25 mm.

31. The trigger sprayer of claim 30 wherein the front finger engaging surface has an hourglass configuration such that upper section has dimensions that are substantially identical to those of the lower section.

32. The trigger sprayer of claim 23 wherein the pump comprises a pump chamber with a piston reciprocally slidaebly positioned therein and the upper section of the lever is operatively attached to the piston.

33. The trigger sprayer of claim 23 wherein at least a portion of the perimeter edge of the finger engaging surface is rounded.
